(19) United States
(12) Patent Application Publication
(10) Pub. No.: US 2022/0057113 A1
(43) Pub. Date: Feb. 24, 2022

(54) BEARING ASSEMBLY FOR TRACKER ASSEMBLY AND METHODS OF MAKING AND USING THE SAME

(71) Applicant: SAINT-GOBAIN PERFORMANCE PLASTICS CORPORATION, Solon, OH (US)

(72) Inventors: Akhilesan SASIDHARAN, Chennai (IN); Sasi Kiran TALLAM, Vijayawada (IN); Sumi DINKAR, Bangalore (IN); Lukas PLIOSKA, Nettetal (DE); Juan VAYA VALCARCE, Barcelona (ES)

(21) Appl. No.: 17/416,951

(22) PCT Filed: Dec. 22, 2019
(86) PCT No.: PCT/IN2019/050947

§ 371 Date: Jun. 21, 2021

(30) Foreign Application Priority Data
Dec. 22, 2018 (IN) 201841048811

(51) Int. Cl. F24S 50/20; F24S 30/425; H02S 20/32

(52) U.S. Cl. CPC F24S 50/20; H02S 20/32; F24S 30/425

(57) ABSTRACT

A bearing assembly for a tracker assembly of a power generation structure including an adaptor configured to be fixed to and rotatable with a rail; and a housing adapted to support the adaptor, where the adaptor is configured to rotate relative to the housing, and where a low friction material is present at an interface between an exterior surface of adaptor and an interior surface of housing.

### TECHNICAL FIELD

The following disclosure relates to bearing assemblies for tracker assemblies with exemplary uses in renewable energy structures.

### BACKGROUND

Tracking assemblies are typically used in radar, light shelf, antennas, solar panels, automobiles and other applications which require continuous rotary motion. One common example of tracker assembly used in the industry are solar trackers for use with renewable energy source assemblies. Solar trackers conventionally include a mounting means to mount solar panels. The mounting means of the solar tracker is designed to change its orientation of the solar panels so as to reflect the sun's position to maximize efficiency. Yet, as the industries surrounding renewable energy sources and tracker assemblies continue to mature, improvements in the components responsible for ensuring power generation will be demanded to improve efficiency, provide lower maintenance, increase deployment potential, and lower the cost of installation.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of a side view of a power generation structure that includes a tracking assembly in accordance with an embodiment.

FIG. 2 includes an illustration of a side view of a bearing assembly for the tracking assembly in accordance with an embodiment.

FIG. 3A includes an illustration of a side view of the adaptor for the tracking assembly according to an embodiment.

FIG. 3B includes an illustration of a cross-sectional view of a first adaptor member of an adaptor around a rail in the radial direction for a tracking assembly according to an embodiment.

FIG. 4 includes an illustration of a side view of a bearing assembly for the tracking assembly in accordance with an embodiment.

FIG. 5A includes an illustration of a top cross-sectional view of a bearing assembly for the tracking assembly in accordance with an embodiment.

FIG. 5B includes an illustration of a top cross-sectional view of a bearing assembly for the tracking assembly in accordance with an embodiment.

FIG. 6 includes a method of producing a material strip for a bearing assembly in accordance with an embodiment;

FIG. 7A includes a cross-sectional view of one embodiment of a material strip for a bearing assembly in accordance with an embodiment;

FIG. 7B includes a cross-sectional view of one embodiment of a material strip for a bearing assembly in accordance with an embodiment;

FIG. 7C includes a cross-sectional view of one embodiment of a material strip for a bearing assembly in accordance with an embodiment; and

FIG. 7D includes a cross-sectional view of one embodiment of a material strip for a bearing assembly in accordance with an embodiment.

FIG. 8 includes a graph of testing of load as a function of deformation conducted for 10,000 cycles at 4.4 kN on an embodiment of the bearing assembly according to embodiments herein.

The use of the same reference symbols in different drawings indicates similar or identical items.

### DETAILED DESCRIPTION OF THE PREFERRED EMBODIMENT(S)

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the bearing and bearing assembly arts.

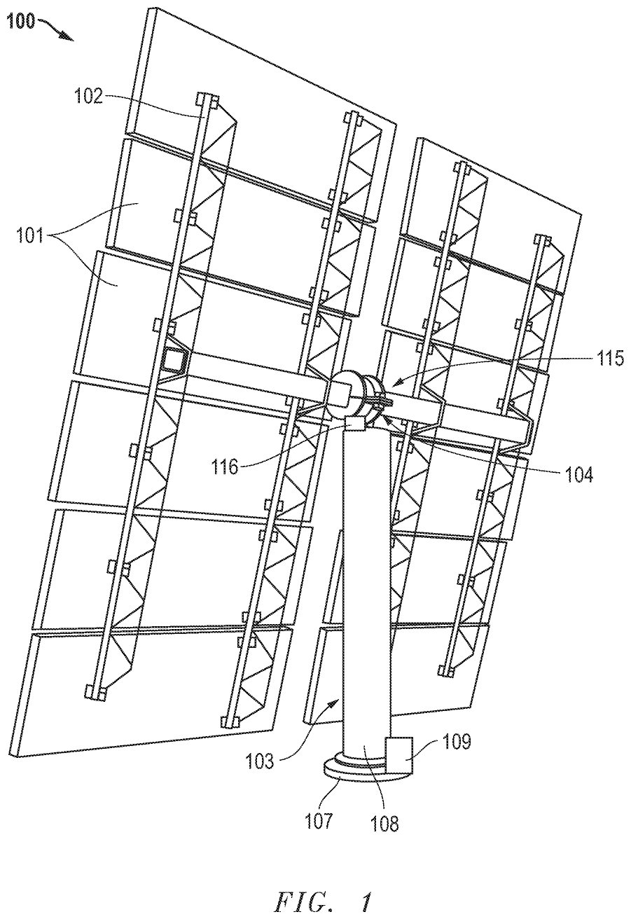

FIG. 1 includes an illustration of a side view of a power generation structure that includes a tracking assembly in accordance with an embodiment. In particular, the tracking assembly 100 may be particularly suitable for utilizing solar power, and converting solar energy to electrical energy. As illustrated, the tracking assembly 100 can include a base 103, including a foundation 107, which may be directly attached to the ground for securing the structure 100 in its location. As further illustrated, the base 103 can include a pedestal 108 directly connected to the foundation 107 and extending upward from the foundation 107 for support and connection of other components of the structure 100. As further illustrated, the base 103 can include a power terminal 109 attached to the foundation 107, which may supply energy to motors used to move portions of the structure 100. The ability to adjust the height of the tracking assembly 104 via the power terminal 109 extending the pedestal 108 is also contemplated herein.

The power generation structure 100 can further include tracker assembly 104 including a bearing assembly 115 attached to the base 103, and in particular, directly attached to the pedestal 108, and configured to move a rail 118 operably connected to the bearing assembly 115. The bearing assembly 115 as described herein may refer to a movable interface between at least two components, where one of the components is designed to move relative to the other component. Types of movement can include simple translation (along one axis), compound translation (along two or more axes), simple rotation (around one axis) compound rotation (around two or more axes), and a combination thereof. The tracker assembly 104 can further include a drive mechanism 116 that may include a motor, which aids movement of the bearing assembly 115 and the rail 118. In particular, the drive mechanism 116 can be programmed such that it changes the position of the rail 118, and thus, the position of photovoltaic (solar) panels 101 that may be attached to the rail 118, such that the panels 101 can follow the position of the sun in the sky for efficient collection and/or direction of radiant beams of energy from the sun. As will be appreciated, movement of the rail 118 can facilitate movement of portions of the structure 100, and in particular, panels 101 that are attached to the rail 118 via support structures 102. For example, the rail 118 may be adapted to rotatably support the panels 101 about a rotational axis. As illustrated, the structure 100 can include an array of panels 101 attached to a single base 103. According to one embodiment, the panels 101 can be energy conversion structures, such as solar panels, configured to convert radiant energy of the sun into electrical power. In another embodiment, the panels 101 of the article can be reflectors, such as mirrors, designed to re-direct the radiant energy of the sun to nearby energy conversion structures, such as solar panels.

While not illustrated, the structure 100 can include other bearing assemblies, such as between the foundation 107 and the pedestal 108 for rotation of the pedestal relative to the foundation 107. Moreover, it will be appreciated that other energy conversion structures can utilize a bearing assembly 115, and particularly components disclosed herein within the bearing assembly 115. For example, another suitable energy conversion structure can include a wind turbine, which may include a plurality of propellers (or vanes) extending from a central structure, wherein the turbines must be allowed to rotate for the generation of electrical power, and thus, may utilize components disclosed herein at a bearing assembly within the structure.

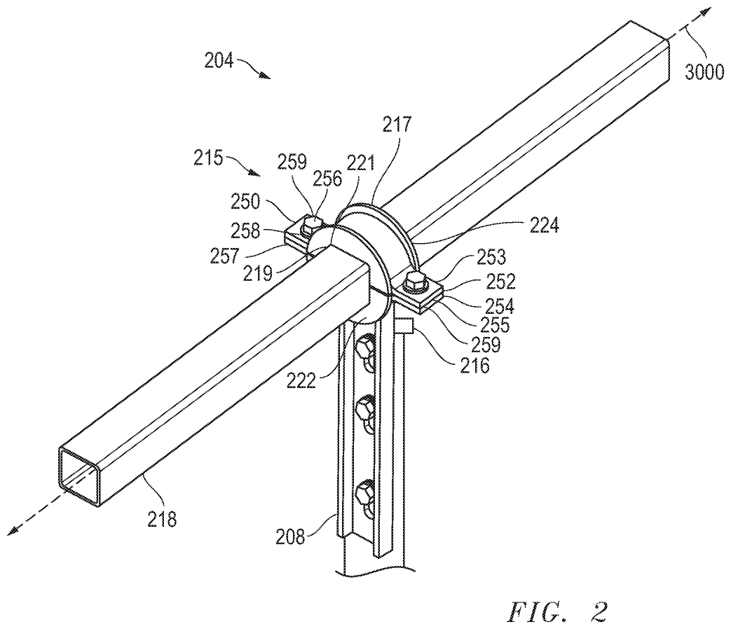

FIG. 2 includes an illustration of a side view of a bearing assembly for the tracking assembly in accordance with an embodiment. The bearing assembly 215 of the tracking assembly 204 may be placed on the pedestal 208 and operated operably connected to the drive mechanism 216. The bearing assembly 215 of the tracking assembly 204 can include an adaptor 217 configured to support the rail 218 directed down a rotational axis 3000. The adaptor 217 may include a first adaptor member 222 and a second adaptor member 224 that at least partially surround a portion of the rail 218 as described in further detail below. As shown in FIG. 2, an exterior surface 219 of the rail 218 may have a non-circular cross-section when viewed in cross-section perpendicular to the rotational axis 3000. In some embodiments, the exterior surface 219 of the rail 218 may have a polygonal cross-section when viewed in cross-section perpendicular to the rotational axis 3000. As shown, the exterior surface 219 of the rail 218 may have a square cross-section but triangular, pentagonal, hexagonal, or other polygonal cross-sections are contemplated herein. Further, in some embodiments, the exterior surface 219 of the rail 218 may have an oval, semi-circular, or other cross-section that is non-circular when viewed in cross-section perpendicular to the rotational axis 3000. Further as shown in FIG. 2, an interior surface 221 of the adaptor 217 may have a non-circular cross-section when viewed in cross-section perpendicular to the rotational axis 3000. In some embodiments, the interior surface 221 of the adaptor 217 may have a polygonal cross-section when viewed in cross-section perpendicular to the rotational axis 3000. As shown, the interior surface 221 of the adaptor 217 may have a square cross-section but triangular, pentagonal, hexagonal, or other cross-sections are contemplated herein. Further, the interior surface 221 of the adaptor 217 may have an oval, semi-circular, or other cross-section that is non-circular when viewed in cross-section perpendicular to the rotational axis 3000. The interior surface 221 of the adaptor may be complementary to the exterior surface 219 of the rail 218 so that they are complementary to each other and may generally fix or couple the rail 218 and the adaptor 217 such that they are rotatable as a single paired component about the rotational axis 3000. In other words, the rail 218 and the adaptor 217 may be fixed and rotatable together about a rotational axis 3000 due to their paired surfaces. In some embodiments, the adaptor 217 can further include secondary components (not shown) that may facilitate the movement of the rail 218, including for example bearing members, suitable for facilitating the sliding of the rail 218 axially relative to the adaptor 217.

Still referring to FIG. 2, the bearing assembly 215 of the tracking assembly 204 may further include a housing 250. The housing 250 may be adapted to support the adaptor 217 and the rail 218. In some embodiments, the housing 250 may have a first housing member 252 and a second housing member 254 that may be used to at least partially fasten the rail 218 and the adaptor 217 together such that they may not move apart from each other in a radial direction relative to the rotational axis 3000. The adaptor 217 and/or rail 218 may be configured to rotate relative to the housing 250 around the rotational axis 3000. The first housing member 252 may have an exterior surface 253 and an interior surface 255. The second housing member 254 may have an exterior surface 257 and an interior surface 259. The interior surface 255 of the first housing member 252 and the interior surface 259 second housing member 254 of the housing may be contacting or contiguous with each other via a mechanical interface that couples the two pieces together. This mechanical interface may be fixed with at least one fastener 256 to fix the first housing member 252 and the second housing member 254 together. The fastener 256 may include at least one of nuts, bolts, battens, buckles, clips, flanges, frogs, grommets, hook-and-eyes, latches, pegs, nails, rivets, tongue-and grooves, screw anchors, snap fasteners, stitches, threaded fasteners, ties, toggle bolts, wedges anchors, or may be attached a different way. In the embodiment shown, the fastener 256 may include holes 258 in the housing members that align for the insertion of screws 259, whereby tightening the adaptor 217 to the pedestal 208. In this way, the first housing member 252 and the second housing member 254 may function as a clamp around the adaptor 217.

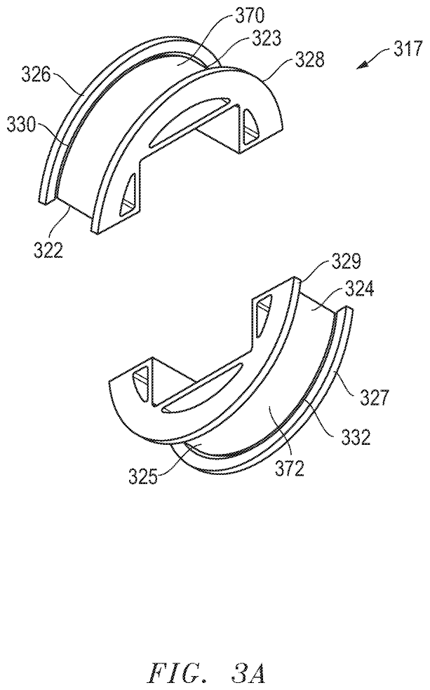

FIGS. 3A-3B include views of the adaptor for the tracking assembly according to embodiments herein. FIG. 3A includes an illustration of a side view of the adaptor for the tracking assembly according to an embodiment. FIG. 3B includes an illustration of a cross-sectional view of a first adaptor member of an adaptor around a rail in the radial direction for a tracking assembly according to an embodiment. As stated above, the adaptor 317 may include a first adaptor member 322 and a second adaptor member 324 coupled thereto. The first adaptor member 322 and the second adaptor member 324 may each include an exterior surface (323, 325). The exterior surface 323, 325 of the first adaptor member 322 and the second adaptor member 324 may each include an arc shaped structure, so as to form a circular shaped structure for an exterior portion of the adaptor 317. Each of the first adaptor member 322 and the second adaptor member 324 may include a pair of side portions (326, 328, 327, 329) facing each other and extending axially from the exterior surface 323, 325 of each of the first adaptor member 322 and the second adaptor member 324. The pair of side portions (326, 328, 327, 329) may form a circumferential groove 330, 332 that is a part of the exterior surface 323, 325 of each of the first adaptor member 322 and the second adaptor member 324 of the adaptor 317. In a number of embodiments, a material strip 370, 372 may be mounted or disposed against the exterior surface 323, 325 of the first adaptor member 322 and/or second adaptor member 324. The material strip 370, 372 may be placed within the circumferential groove 330, 332 of the first adaptor member 322 and/or the second adaptor member 324. In an embodiment, a plurality of material strips 370, 372 may be placed within the circumferential groove 330, 332 of the first adaptor member 322 and the second adaptor member 324. As shown best in FIG. 3B, the adaptor 317 may have a first adaptor member 322 that may be placed radially outside of a rail 318 in the tracker assembly 304. The adaptor 317 and/or first adaptor member 322 may further include slits (331, 333) that cut into the thickness of the side portions (326, 238) of the first adaptor member 322. The second adaptor member 324 may also include corresponding slits. The slits may be used to accommodate the material strip to mechanically fix the material strip(s) to the adaptor 317. The material strip may be mounted by sliding through the slits to affix to the exterior surface 323, 325 of at least one of the first adaptor member 322 or the second adaptor member 324 of the adaptor 317 inside the circumferential groove 330, 332.

Further, as shown in FIG. 2, the interior surface 255 of the first housing member 252 and the interior surface 259 second housing member 254 may form an interface with or be closely adjacent to the exterior surface of the first adaptor member and/or second adaptor member. As shown in FIGS. 3-3B a material strip 370, 372 may be placed between at least one of the interior surface of the first housing member or the interior surface second housing member and exterior surface 323, 325 of the first adaptor member 322 or second adaptor member 324. For example, as shown best in FIG. 3B, the strip 370 may be placed in the groove 330 of the first adaptor member 322 while the interior surface of the first housing member may be sized to overlie the strip 370 within the groove 330. The material strip 370, 372 may include a low friction material as discussed in further detail below. The low friction material of the material strip 370, 372 at the interface between an interior surface of the housing and the exterior surface 323, 325 of the adaptor 317 may permit movement or slip of the adaptor 317 (and fixed rail) relative to the housing or vice versa by providing a desired slip interface. In an embodiment shown in FIGS. 3A-3B, the material strip 370, 372 including the low friction material may be fixed to an exterior surface 323, 325 of at least one of the first adaptor member 322 or the second adaptor member 324 of the adaptor 317. For example, this may be done by fixing the material strip 370 within the groove 330 of the first adaptor member 322 with the slits (331, 333) in the first adaptor member 322 of the adaptor 317 as described above. In another embodiment, as discussed in further detail below, the material strip 370, 372 may be preformed according to the shape of the adaptor 317. For example, the material strip 370 may be sized to provide a zero-clearance fit within the groove 330 of the first adaptor member 322 against the side portions 326, 328 and molded or adhesively attached to the first adaptor member 322. In another embodiment, a mechanical stopper may be placed at each end of the groove 330 to keep the material strip 370 in place against the first adaptor member 370. In other embodiments, the material strip 370, 372 may be fixed against the adaptor 317 by use of adhesives, ultrasonic welding, mechanical screwing, or by precision press fitting operations.

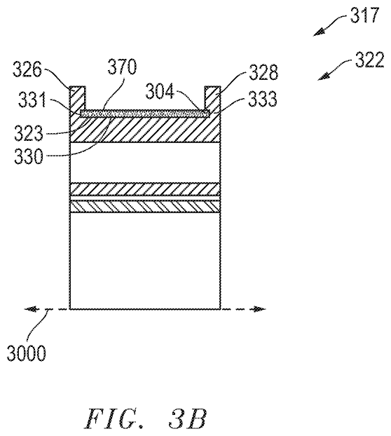

FIG. 4 includes an illustration of a side view of a bearing assembly for the tracking assembly in accordance with another embodiment. It may be understood that all components of the bearing assembly of FIG. 2 may have similar properties, dimensions, shapes, and abilities as corresponding components shown in FIG. 4. The bearing assembly 415 of the tracking assembly 404 may be placed on a pedestal 408. The bearing assembly 415 of the tracking assembly 404 can include an adaptor 417 operably connected to the drive mechanism 416 and configured to support the rail 418. The adaptor 417 in this embodiment may be a single component. Similar to other embodiments, the exterior surface 419 of the rail 418 may have a non-circular (e.g. polygonal) cross-section when viewed in cross-section perpendicular to the rotational axis 3000. The interior surface 421 of the adaptor 418 may also have a non-circular (e.g. polygonal) cross-section when viewed in cross-section perpendicular to the rotational axis 3000 that may be complementary to the exterior surface 419 of the rail so as to generally fix or couple the rail 418 and the adaptor 417 such that they are rotatable as a single paired component about the rotational axis 3000. In some embodiments, the adaptor 417 can further include secondary components (not shown) that may facilitate the movement of the rail 418, including for example bearing members, suitable for facilitating the sliding of the rail 418 around portions of the adaptor 417.

Still referring to FIG. 4, the bearing assembly 415 of the tracking assembly 404 may further include a housing 450. The housing 450 may be adapted to support the adaptor 417 and the rail 418. In some embodiments, the housing 450 may have a first housing member 452 and a second housing member 454 that may be used to at least partially fasten the rail 418 and the adaptor 417 together such that they may not move apart from each other in a radial direction relative to the rotational axis 3000. The first housing member 452 may have an exterior surface 453 and an interior surface 455. The second housing member 454 may have an exterior surface 457 and an interior surface 459. The interior surface 455 of the first housing member 452 and the interior surface 459 second housing member 454 of the housing 450 may be contacting or contiguous with each other via a mechanical interface that couples the two pieces together. This mechanical interface may be fixed with at least one fastener 456 to fix the first housing member 452 and the second housing member 454 together. The fastener 456 may include at least one of nuts, bolts, battens, buckles, clips, flanges, frogs, grommets, hook-and-eyes, latches, pegs, nails, rivets, tongue-and grooves, screw anchors, snap fasteners, stitches, threaded fasteners, ties, toggle bolts, wedges anchors, or may be attached a different way. In the embodiment shown, the fastener 456 may include holes 458 in the housing members that align for the insertion of screws 459, whereby tightening the adaptor 417 to the pedestal.

In a number of embodiments, the second housing member 454 may include multiple components. As shown in FIG. 4, the top second housing member 454a may support the adaptor 417. The bottom second housing member 454b may support the top second housing member 454b. The top second housing member 454a may be substantially similar in shape to the first housing member 452. The bottom second housing member 454b may attach to the pedestal 408.

In the embodiment shown in FIG. 4, an exterior surface 423 of the adaptor 417 may have a rounded shape. Further, an interior surface 455, 459 of the first and second housing members 452, 454 may have a rounded shape complementary to the exterior surface 423 of the adaptor 417Thus, an interior surface 455, 459 of the first and second housing members 452, 454 may have a rounded shape adapted to couple to the exterior surface 423 of the adaptor 417. In a number of embodiments, the exterior surface 423 of the adaptor 417 may have a partially spherical shape. Further, an interior surface 455, 459 of the first and second housing members 452, 454 may have a partially spherical shape that complements the exterior surface of the adaptor 417 so as to form a swivel interface. In an embodiment, the exterior surface 453 of the first housing member 452 and the exterior surface 457 of the second housing member 454 may also have a partially spherical shape. In another embodiment, an interior surface 461 of the bottom second housing member 454b may have a partially spherical shape that complements the exterior surface 457 of the top second housing member 454a.

Further, as shown in FIG. 4, the interior surface 455 of the first housing member 452 and the interior surface 459 second housing member 454 may form an interface with or be closely adjacent to the exterior surface 423 of the adaptor 417. A material strip 470, 472 may be placed between at least one of the interior surface 455 of the first housing member 452 or the interior surface 459 second housing member 454 and the exterior surface 423 of the adaptor 417. The material strip 470, 472 may include a low friction material as discussed in further detail below. The low friction material of the material strip 470, 472 at the interface between an interior surface 455, 459 of the housing 450 and the exterior surface 423 of the adaptor 417 may permit movement or slip of the adaptor 417 (and fixed rail 418) relative to the housing 450 or vice versa by providing a desired slip interface. In an embodiment shown in FIG. 4, the material strip 470, 472 including the low friction material may be fixed to an interior surface 455, 459 of at least one of the first housing member 452 or the second housing member 454 of the housing 450. For example, this may be done by fixing the material strip 470 to interior surface 455, 459 of at least one of the first housing member 452 or the second housing member 454 of the housing 450. In another embodiment, as discussed in further detail below, the material strip 470, 472 may be preformed according to the shape of the housing 450. For example, the material strip 470, 472 may be sized to provide a zero-clearance fit to the interior surface 455, 459 of at least one of the first housing member 452 or the second housing member 454 of the housing 450 and be molded or adhesively attached to at least one of the first housing member 452 or the second housing member 454 of the housing 450. In other embodiments, the material strip 470, 472 may be fixed against the adaptor 450 by use of adhesives, ultrasonic welding, mechanical screwing, or by precision press fitting operations. Further, the low friction material of the material strip 470, 472 may act as a clamp or as an aid in the clamp of the first housing member 452 and the second housing member 454 of the housing 450 against the adaptor 417. This may be done as the low friction material may provide an elastic behaviour that may better fit the housing 450 to the adaptor 450 and provide a greater clamping force against the adaptor 450.

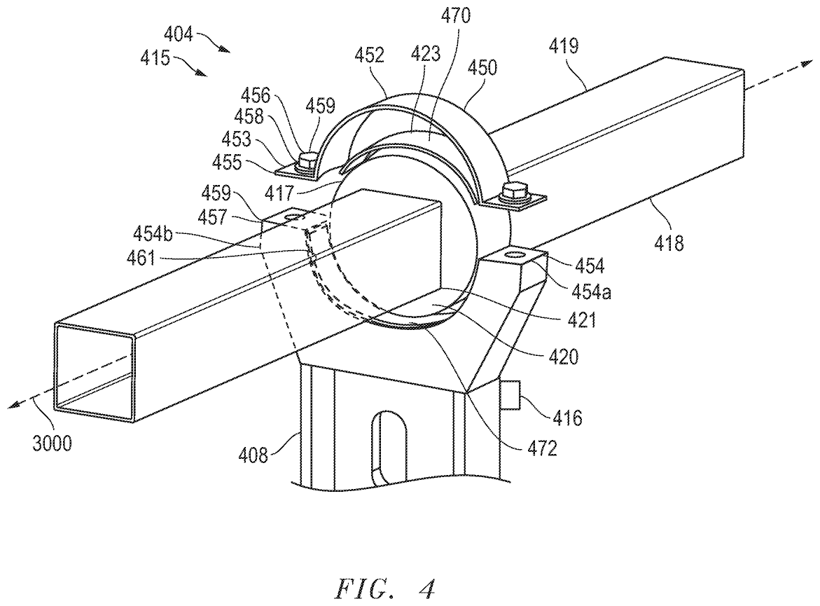

FIGS. 5A and 5B include illustrations of a top cross-sectional view of a bearing assembly for the tracking assembly in accordance with another embodiment. It may be understood that all components of the bearing assembly of FIG. 4 may have similar properties, dimensions, shapes, and abilities as corresponding components shown in FIGS. 5A and 5B. As seen in the views of FIGS. 5A, and 5B, the bearing assembly 515 of the tracking assembly 504 may include a swivel mount of the rail 518 and the adaptor 517 relative to the housing 550 that allows rotation of the rail 518 without additional components bracing the rail 518 (and affixed adaptor 517) from being able to come out of the housing 550 due to axial and/or rotational movement of the rail 518. In a number of embodiments, the rail 518 can be deviated axially with respect to the rotational axis in the axial direction due to the swivel mount of the rail 518 and adaptor 517 within the housing 550. In a number of embodiments, the rail 518 can be deviated in the transverse direction with respect to the rotational axis in the axial direction due to the swivel mount of the rail 518 and adaptor 517 within the housing 550. The swivel mount of the rail 518 and adaptor 517 within the housing 550 thus allows spatial orientation of the rail 518 in any required position. Material strips 570, 572 may be placed at the interface between the adaptor 517 and housing 550 as described above to aid in the movement of the adaptor 517 relative to the housing.

In an embodiment therein, the adaptor, rail, and or housing (or any components thereof) may at least partially include a metal. According to certain embodiments, the metal may include iron, copper, titanium, tin, aluminum, alloys thereof, or may be another type of metal. In a number of embodiments, the adaptor, rail, and or housing (or any components thereof) may include a polymer. In an embodiment, the adaptor, rail, and or housing (or any components thereof) may be made a plastic polymer. The plastic polymer may be selected from the group including a polyketone, a polyaramid, a polyphenylene sulfide, a polyethersulfone, a polypheylene sulfone, a polyamideimide, ultra high molecular weight polyethylene, a fluoropolymer, a polybenzimidazole, a polyacetal, polybutylene terephthalate (PBT), polypropylene (PP), polycarbonate (PC), Acrylonitrile butadiene styrene (ABS), polyethylene terephthalate (PET), a polyimide (PI), polyetherimide, polyetheretherketone (PEEK), polyethylene (PE), a polysulfone, a polyamide (PA), polyphenylene oxide, polyphenylene sulfide (PPS), a polyurethane, a polyester, a liquid crystal polymer (LCP), or any combination thereof. The plastic polymer may be a thermoplastic or thermosetting polymer. In an embodiment therein, the adaptor, rail, and or housing (or any components thereof) may also includes glass filler, silica, clay mica, kaolin or other synthetic fillers. In an embodiment therein, the adaptor, rail, and or housing (or any components thereof) may be constructed by at least one of a chamfering, turning, reaming, forging, extruding, molding, sintering, rolling, or casting, injection molding, or 3-D printing. The adaptor, rail, and or housing (or any components thereof) of embodiments herein can utilize one or more combinations of features, including particular materials, thicknesses of the material, dimensions of the component, and certain mechanical properties (e.g., stiffness), and chemical inertness that are desired in the industry.

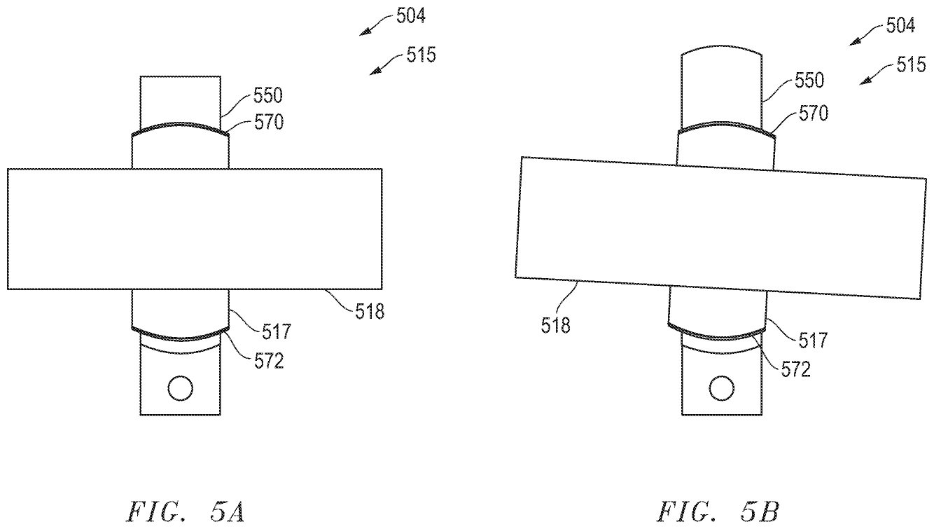

As stated above, in a number of embodiments, a material strip may be mounted, affixed, or otherwise disposed against the exterior surface of the adaptor (first adaptor member and/or second adaptor member). Further, as stated above, in a number of embodiments, a material strip may be mounted, affixed, or otherwise disposed against the interior surface of the housing (first housing member and/or second housing member). For purposes of illustration, FIG. 6 includes a diagram showing a forming process 610 for forming the material strip. The forming process 610 may include a first step 612 of providing a material including a low friction material. Optionally, the forming process 10 may further include a second step 14 of placing a substrate against the low friction material to form a material strip.

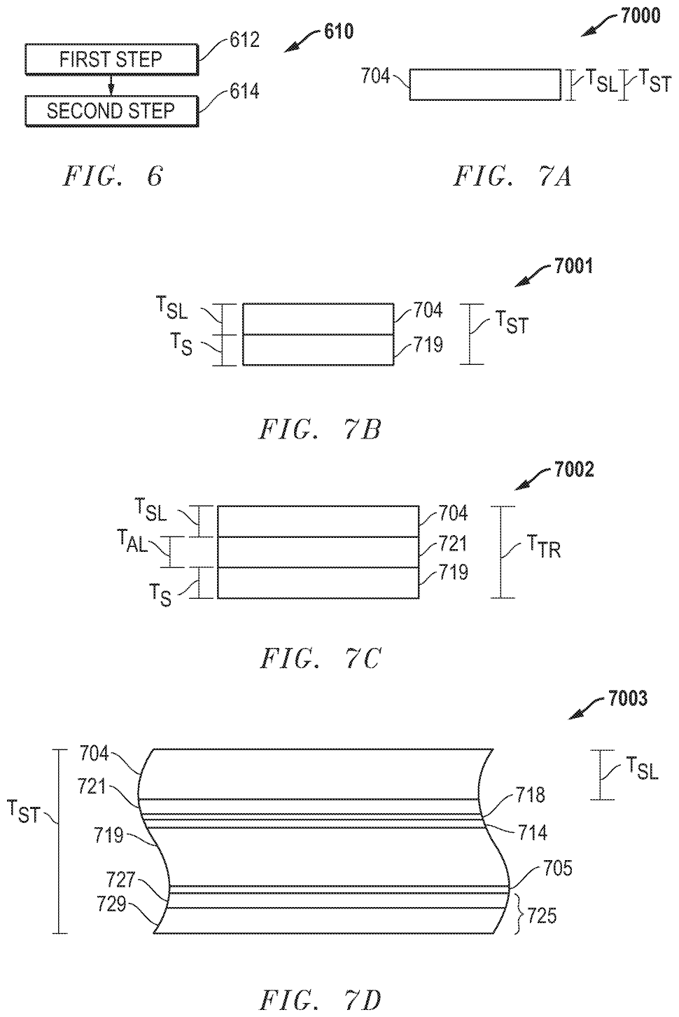

FIG. 7A includes an illustration of a material strip 7000 that may be formed using the first step 612 of the forming process 610 shown in FIG. 6. In a number of embodiments, the material strip 7000 may include a low friction layer 704. In a number of embodiments, the low friction layer 704 can include a low friction material. Low friction materials may include, for example, a polymer, such as a polyketone, a polyaramid, a polyphenylene sulfide, a polyethersulfone, a polypheylene sulfone, a polyamideimide, ultra high molecular weight polyethylene, a fluoropolymer, a polybenzimidazole, a polyacetal, polybutylene terephthalate (PBT), polyethylene terephthalate (PET), a polyimide (PI), polyetherimide, polyetheretherketone (PEEK), polyethylene (PE), a polysulfone, a polyamide (PA), polyphenylene oxide, polyphenylene sulfide (PPS), a polyurethane, a polyester, a liquid crystal polymer (LCP), or any combination thereof. In an example, the low friction layer 704 includes polyketone, such as polyether ether ketone (PEEK), polyether ketone, polyether ketone ketone, polyether ketone ether ketone, a derivative thereof, or a combination thereof. In an additional example, the low friction layer 704 may include an ultra high molecular weight polyethylene. In another example, the low friction layer 704 may include a fluoropolymer including fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), or ethylene chlorotrifluoroethylene copolymer

(ECTFE). The low friction layer 704 may be a thermoplastic or thermosetting polymer. The low friction layer 704 may include a solid based material including lithium soap, graphite, boron nitride, molybdenum disulfide, tungsten disulfide, polytetrafluoroethylene, carbon nitride, tungsten carbide, or diamond like carbon, a metal (such as aluminum, zinc, copper, magnesium, tin, platinum, titanium, tungsten, iron, bronze, steel, spring steel, stainless steel), a metal alloy (including the metals listed), an anodized metal (including the metals listed) or any combination thereof. Fluoropolymers may be used according to particular embodiments. In an embodiment, the low friction layer 704 may include a woven mesh or an expanded metal grid where the low friction material is embedded within and impregnating the woven mesh or expanded metal grid. The woven mesh or expanded metal grid can include a metal or metal alloy such as aluminum, steel, stainless steel, bronze, or the like. Alternatively, the woven mesh can be a woven polymer mesh made of low friction material.

In a number of embodiments, the low friction layer 704 may further include fillers, including glass fibers, carbon fibers, silicon, PEEK, aromatic polyester, carbon particles, bronze, fluoropolymers, thermoplastic fillers, aluminum oxide, polyamidimide (PAI), PPS, polyphenylene sulfone (PPSO2), LCP, aromatic polyesters, molybdenum disulfide, tungsten disulfide, graphite, grapheme, expanded graphite, boron nitrade, talc, calcium fluoride, or any combination thereof. Additionally, the filler can include alumina, silica, titanium dioxide, calcium fluoride, boron nitride, mica, Wollastonite, silicon carbide, silicon nitride, zirconia, carbon black, pigments, or any combination thereof. Fillers can be in the form of beads, fibers, powder, mesh, or any combination thereof. The fillers may be at least 10 wt % based on the total weight of the low friction layer, such as at least 15 wt %, 20 wt %, 25 wt % or even 30 wt %.

In an embodiment, the low friction layer 704 can have a thickness TSL of about 0.001 mm to about 20 mm. In a number of embodiments, the low friction layer 704 can have a thickness TSL of about 0.5 mm to about 3 mm. It will be further appreciated that the thickness TSL of the low friction layer 704 may be any value between any of the minimum and maximum values noted above. The thickness of the low friction layer 704 may be uniform, i.e., a thickness at a first location of the low friction layer 704 can be equal to a thickness at a second location therealong. The thickness of the low friction layer 704 may be non-uniform, i.e., a thickness at a first location of the low friction layer 704 can be different than a thickness at a second location therealong. It can be appreciated that different low friction layers 704 may have different thicknesses.

FIG. 7B includes an illustration of another embodiment of a material strip 7001, alternative to the material strip 7000, that may be formed using the first step 612 of the forming process 610 shown in FIG. 6. For purposes of illustration, FIG. 7B shows the layer by layer configuration of a material strip 7001. The material strip 7001 may include a substrate 719. In an embodiment, the substrate 719 can at least partially include a metal. According to certain embodiments, the metal may include iron, copper, titanium, tin, aluminum, alloys thereof, or may be another type of metal. More particularly, the substrate 719 can at least partially include a steel, such as, a stainless steel, carbon steel, or spring steel. For example, the substrate 719 can at least partially include a 301 stainless steel. The 301 stainless steel may be annealed, ¼ hard, ½ hard, ¾ hard, or full hard. Moreover, the steel can include stainless steel including chrome, nickel, or a combination thereof. In an embodiment, the substrate 719 may include a woven mesh or an expanded metal grid. The woven mesh or expanded metal grid can include a metal or metal alloy such as aluminum, steel, stainless steel, bronze, or the like. Alternatively, the woven mesh can be a woven polymer mesh. In an alternate embodiment, the substrate 719 may not include a mesh or grid. Further, the substrate 719 can include a Vickers pyramid number hardness, VPN, which can be ≥350, such as ≥375, ≥400, ≥425, or ≥450. VPN can also be ≤500, ≤475, or ≤450. VPN can also be within a range between, and including, any of the VPN values described herein. In another aspect, the substrate 719 can be treated to increase its corrosion resistance. In particular, the substrate 719 can be passivated. For example, the substrate 719 can be passivated according to the ASTM standard A967. The substrate 719 may be formed by at least one of chamfering, turning, reaming, forging, extruding, molding, sintering, rolling, or casting.

In an embodiment, the substrate 719 can have a thickness Ts of about 0.001 mm to about 10 mm. It will be further appreciated that the thickness Ts of the substrate 719 may be any value between any of the minimum and maximum values noted above. The thickness of the substrate 719 may be uniform, i.e., a thickness at a first location of the substrate 719 can be equal to a thickness at a second location therealong. The thickness of the substrate 719 may be non-uniform, i.e., a thickness at a first location of the substrate 719 can be different than a thickness at a second location therealong.

Still referring to FIG. 7B, in a number of embodiments, the material strip 7001 may include substrate 719 (and low friction layer 704 coupled to or overlying the substrate 719. In a more particular embodiment, the material strip 7001 may include a substrate 719 and a plurality of one low friction layers 704 overlying the substrate 719. In a particular embodiment, the low friction layer 704 can be coupled to a surface of the substrate 719 so as to form an interface with another surface of another component. The low friction layer 704 can be coupled to the radially inner surface of the substrate 719. Alternatively, the low friction layer 704 can be coupled to the radially outer surface of the substrate 719. In another alternate embodiment, the substrate 719, as a solid component, woven mesh or expanded metal grid, may be embedded or impregnated with the low friction layer 704. In an embodiment, the substrate 719 may be at least partially encapsulated by the low friction layer 704. That is, the low friction layer 104 may cover at least a portion of the substrate 719.

FIG. 7C includes an illustration of an alternative embodiment of the material strip 7002, alternative to the material strips 7000, 7001, that may be formed into the material strip of the first step 12 of the forming process 10. For purposes of illustration, FIG. 2C shows the layer by layer configuration of a material strip 7002 of the material strip. According to this particular embodiment, the material strip 1002 may be similar to the material strip 7001 of FIG. 7B, except this material strip 7002 may also include at least one adhesive layer 721 that may couple the low friction layer 704 to the substrate 719 and a low friction layer 704. In another alternate embodiment, the substrate 719, as a solid component, woven mesh or expanded metal grid, may be embedded between at least one adhesive layer 721 included between the low friction layer 704 and the substrate 719.

The adhesive layer 721 may include any known adhesive material common to the ring arts including, but not limited to, fluoropolymers, epoxy resins, polyimide resins, polyether/polyamide copolymers, ethylene vinyl acetates, ethylene tetrafluoroethylene (ETFE), ETFE copolymer, perfluoroalkoxy (PFA), or any combination thereof. Additionally, the adhesive can include at least one functional group selected from —C═O, —C—O—R, —COH, —COOH, —COOR, —CF₂═CF—OR, or any combination thereof, where R is a cyclic or linear organic group containing between 1 and 20 carbon atoms. Additionally, the adhesive can include a copolymer.

Filler particles (functional and/or nonfunctional) may be added in to the adhesive layer 721 such as carbon fillers, carbon fibers, carbon particles, graphite, metallic fillers such as bronze, aluminum, and other metals and their alloys, metal oxide fillers, metal coated carbon fillers, metal coated polymer fillers, or any combination thereof.

In an embodiment, the hot melt adhesive can have a melting temperature of not greater than 250° C., such as not greater than 220° C. In another embodiment, the adhesive may break down above 200° C., such as above 220° C. In further embodiments, the melting temperature of the hot melt adhesive can be higher than 250° C. or even higher than 300° C. The adhesive layer 721 can have a thickness T_{AL} of about 0.040 mm to about 10 mm. In another embodiment, the adhesive layer 721 can have a thickness T_{AL} of about 8 mm to about 10 mm. It will be further appreciated that the thickness T_{AL} of the adhesive layer 721 may be any value between any of the minimum and maximum values noted above. The thickness of the adhesive layer 721 may be uniform, i.e., a thickness at a first location of the adhesive layer 721 can be equal to a thickness at a second location therealong. The thickness of the adhesive layer 721 may be non-uniform, i.e., a thickness at a first location of the adhesive layer 721 can be different than a thickness at a second location therealong.

FIG. 7D includes an illustration of an alternative embodiment of the material strip 7003, alternative to the material strips 7000, 7001, 7002, which may be formed into the material strip of the first step 612 of the forming process 610. For purposes of illustration, FIG. 7D shows the layer by layer configuration of a material strip 7003. According to this particular embodiment, the material strip 7003 may be similar to the material strip 7002 of FIG. 7C, except this material strip 7003 may also include at least one corrosion protection layer 714, 705, and 718, and a corrosion resistant coating 725 that can include an adhesion promoter layer 727 and an epoxy layer 729 that may couple to the substrate 719 and a low friction layer 704.

The substrate 719 may be coated with corrosion protection layers 714 and 705 including corrosion protection material to prevent corrosion of the material strip 7003 prior to processing. Additionally, a corrosion protection layer 718 can be applied over layer 714. Each of layers 714, 705, and 718 can have a thickness of 0.001 mm to about 5 mm. Layers 714 and 705 can include corrosion protection materials including a phosphate of zinc, iron, manganese, or any combination thereof, or a nano-ceramic layer. Further, layers 714 and 705 can include corrosion protection materials including functional silanes, nano-scaled silane based primers, hydrolyzed silanes, organosilane adhesion promoters, solvent/water based silane primers, chlorinated polyolefins, passivated surfaces, aluminum cladding, commercially available zinc (mechanical/galvanic) or zinc-nickel coatings, or any combination thereof. Layer 718 can include functional silanes, nano-scaled silane based primers, hydrolyzed silanes, organosilane adhesion promoters, solvent/water based silane primers. Corrosion protection layers 714, 705, and 718 can be removed or retained during processing.

As stated above, the material strip 7003 may further include a corrosion resistant coating 725. The corrosion resistant coating 725 can include an adhesion promoter layer 727 and an epoxy layer 729. The adhesion promoter layer 727 can include corrosion protection materials including phosphate of zinc, iron, manganese, tin, or any combination thereof, or a nano-ceramic layer. The adhesion promoter layer 727 can include corrosion protection materials including functional silanes, nano-scaled silane based layers, hydrolyzed silanes, organosilane adhesion promoters, solvent/water based silane primers, chlorinated polyolefins, passivated surfaces, commercially available zinc (mechanical/galvanic) or Zinc-Nickel coatings, or any combination thereof. The adhesion promoter layer 727 can be applied by spray coating, e-coating, dip spin coating, electrostatic coating, flow coating, roll coating, knife coating, coil coating, or the like.

The epoxy layer 729 can be corrosion protection materials including a thermal cured epoxy, a UV cured epoxy, an IR cured epoxy, an electron beam cured epoxy, a radiation cured epoxy, or an air cured epoxy. Further, the epoxy layer 729 can include corrosion protection materials including polyglycidylether, diglycidylether, bisphenol A, bisphenol F, oxirane, oxacyclopropane, ethylenoxide, 1,2-epoxypropane, 2-methyloxirane, 9,10-epoxy-9,10-dihydroanthracene, or any combination thereof. The epoxy layer 729 can further include a hardening agent. The hardening agent can include amines, acid anhydrides, phenol novolac hardeners such as phenol novolac poly[N-(4-hydroxyphenyl)maleimide] (PHPMI), resole phenol formaldehydes, fatty amine compounds, polycarbonic anhydrides, polyacrylate, isocyanates, encapsulated polyisocyanates, boron trifluoride amine complexes, chromic-based hardeners such as chromium, polyamides, or any combination thereof. Generally, acid anhydrides can conform to the formula R—C═O—O—C═O—R′ where R can be C_{X}H_{Y}X_{Z}A_{U} as described above. Amines can include aliphatic amines such as monoethylamine, diethylenetriamine, triethylenetetraamine, and the like, alicyclic amines, aromatic amines such as cyclic aliphatic amines, cyclo aliphatic amines, amidoamines, polyamides, dicyandiamides, imidazole derivatives, and the like, or any combination thereof. Generally, amines can be primary amines, secondary amines, or tertiary amines conforming to the formula R₁R₂R₃N where R can be C_{X}H_{Y}X_{Z}A_{U} as described above. In an embodiment, the epoxy layer 729 can include fillers to improve the conductivity, such as carbon fillers, carbon fibers, carbon particles, graphite, metallic fillers such as bronze, aluminum, and other metals and their alloys, metal oxide fillers, metal coated carbon fillers, metal coated polymer fillers, or any combination thereof. The conductive fillers can allow current to pass through the epoxy coating and can increase the conductivity of the material strip as compared to a material strip without conductive fillers. In an embodiment, the epoxy layer 729 can be applied by spray coating, e-coating, dip spin coating, electrostatic coating, flow coating, roll coating, knife coating, coil coating, or the like. Additionally, the epoxy layer 729 can be cured, such as by thermal curing, UV curing, IR curing, electron beam curing, irradiation curing, or any combination thereof. Preferably, the curing can be accomplished without increasing the temperature of the component above the breakdown temperature of any of the low friction layer 704, the adhesive layer 721, the substrate 719, or the adhesion promoter layer 727. Accordingly, the epoxy may be cured below about 250° C., even below about 200° C.

In an embodiment, under step 12 of FIG. 6, any of the layers on the material strip 7000, 7001, 7002, 7003, as described above in reference to FIGS. 7A-7D, can each be disposed in a roll and peeled therefrom to join together under pressure, at elevated temperatures (hot or cold pressed or rolled), by an adhesive, or by any combination thereof. Any of the layers on the material strip 7000, 7001, 7002, 7003, as described above, may be laminated together such that they at least partially overlap one another. Any of the layers on the material strip 7000, 7001, 7002, 7003, as described above, may be applied together using coating technique, such as, for example, physical or vapor deposition, spraying, plating, powder coating, or through other chemical or electrochemical techniques. In a particular embodiment, the low friction layer 704 may be applied by a roll-to-roll coating process, including for example, extrusion coating. The low friction layer 704 may be heated to a molten or semi-molten state and extruded through a slot die onto a major surface of the substrate 719. In an embodiment, the material strip 7000, 7001, 7002, 7003, may be a single unitary strip of material.

In other embodiments, under step 12 of FIG. 6, any of the layers on the material strip 7000, 7001, 7002, 7003 as described above in reference to FIGS. 7A-7D, as described above, may be applied by a coating technique, such as, for example, physical or vapor deposition, spraying, plating, powder coating, or through other chemical or electrochemical techniques. In a particular embodiment, the low friction layer 704 may be applied by a roll-to-roll coating process, including for example, extrusion coating. The low friction layer 704 may be heated to a molten or semi-molten state and extruded through a slot die onto a major surface of the substrate 719. In another embodiment, the low friction layer 704 may be cast or molded.

In an embodiment, the low friction layer 704 or any layers can be glued to the substrate 719 using the melt adhesive layer 721 to form a laminate. In an embodiment, any of the intervening or outstanding layers on the material strip 7000, 7001, 7002, 7003, may form the laminate. The laminate can be cut into strips or blanks that can be formed into the material strip. The cutting of the laminate may include use of a stamp, press, punch, saw, or may be machined in a different way. The material strip may then be formed by stamp, press, punch, saw, rolling, flanging, deep-drawing, or may be machined in a different way to fit the shape of the adaptor or housing as described above. In particular embodiment, the material strip 7000 may be molded directly to one of the adaptor or the housing. In another embodiment, the material strip 7000 may be molded to the adaptor or housing as a layer on the component, resulting in a layered structure similar to FIG. 7B. In still another embodiment, the material strip 7000 may be adhesively affixed to the adaptor or housing as a layer on the component with an adhesive layer therebetween, resulting in a layered structure similar to FIG. 4C. In another embodiment, the material strip 7003 may be affixed in total to the adaptor or housing. After shaping the semi-finished material strip, the semi-finished material strip may be cleaned to remove any lubricants and oils used in the forming and shaping process. Cleaning may include chemical cleaning with solvents and/or mechanical cleaning, such as ultrasonic cleaning.

### EXAMPLES

Examples of material for the adaptor used in the present invention may include a polymer selected from teraphthalate family, styrene family and other composite materials, polymer blends of aforementioned polymers. In another example, the adaptor material may be selected from a group of PET, PBT, PPE, ABS, PC, PP, and poly ethylenes, and any combination thereof. The engineered plastic polymer composite also includes glass filler, silica, clay mica, kaolin or other synthetic fillers. The combination of adaptor material with the material strip in the embodiments herein provides an improved service life of about 15 years to the tracker assembly. Further, the tracking assembly of the present invention provides strength and improved tribological properties at comparatively cheaper costs as shown in Table 1.

TABLE 1

| | | | | | Temper- | | CoF |
|---|---|---|---|---|---|---|---|
| | | | | | ature | Melting | (With |
| | | | | | of | Temper- | steel |
| | | | Tensile | Yield | deflection | ature* | under |
| | | Density* | modulus* | Stress* | under load* | (° C.) @ | dry |
| o. | Material | (kg/m3) | (Mpa) | (Mpa) | (1.8 Mpa) | 10° C./min | contact) |
| | POM | 1420 | 3000 | 71.5 | 92 | 178 | 0.14 |
| | UHMWPE | 940 | 700 | 21 | 79 | 135 | 0.15 |
| | Proposed | 1560 | 11000 | 158 | 224 | 252 | 0.05 |
| | system-1 | | | | | | |
| | Proposed | 1750 | 17200 | 185 | 235 | 280 | 0.05 |
| | system-2 | | | | | | |

*Density, Tensile modulus, Yield stress, Temperature of deflection under load, Melting temperature values are indicated for the housing

The coefficient of friction (CoF) value shown in Table 1 for POM and UHMWPE, refers to the coefficient of present at the surface. In Proposed system 1 and Proposed system 2, the CoF value indicates coefficient of friction of the material strip surface.

With respect to Table 1, the proposed system 1 may be an adaptor and a low coefficient friction material strip. Here, the adaptor may be made with a combination of PET material and 30% glass filler. In another example, the proposed system 2 includes an adaptor and a low coefficient friction material strip. The adaptor may be made of PET and 45% glass filler. As illustrated in Table 1, the proposed system 1 and 2 provides improved coefficient of friction to the adaptor, thereby improving the maintenance life of the tracking assembly. Further, the tracking assembly provides improved weather-ability as compared to existing solutions because of the materials used in the construction of the housing. Thus, the tracking assembly may not be prone to degradation by UV, water, environmental pollutants, dust and the like.

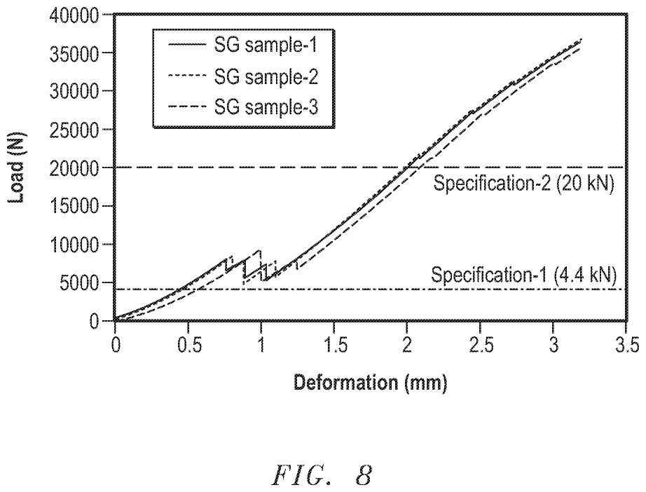

Further, FIG. 8 illustrates testing of load as a function of deformation conducted for 10,000 cycles at 4.4 kN on proposed system 1, 2, and additionally, proposed system 3 according to embodiments herein. As shown in FIG. 8, the proposed systems 1, 2, and 3 according to embodiments of the bearing assemblies used herein may have an improved life span of approximately 28 years when used in renewable energy structures. Further, torque output of the proposed systems 1, 2, and 3 according to embodiments of the bearing assemblies used herein may be relatively steady whereas prior art bearing assemblies may have an increase of torque of approximately 50% from the 1^{st} cycle to the 10,000 cycle. This may indicate higher friction that may wear the bearing assembly faster than bearing assemblies according to embodiments disclosed herein. Further, as shown in FIG. 8, the load carrying capacity of the adaptor of the proposed systems 1, 2, and 3 according to embodiments of the bearing assemblies used herein may be in the range of up to about 30 kN.

The bearing assemblies of the tracker assemblies of the embodiments herein can demonstrate improved operations and characteristics over conventional bearing assemblies of the tracker assemblies. For example, in one embodiment, the bearing assemblies of embodiments herein demonstrate improved resistance to corrosion and weathering. Further, bearing assemblies of embodiments herein demonstrate improved stick-slip performance properties due to the material strip, which are an improvement over conventional bearing members. Therefore, bearing assemblies of the tracker assemblies of the embodiments herein may improve efficiency, provide lower maintenance, lower the cost of installation, and therefore, increase potential deployment of tracker assemblies and/or renewable energy structures.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1: A bearing assembly for a tracker assembly of a power generation structure comprising: an adaptor configured to be fixed to and rotatable with a rail; and a housing adapted to support the adaptor, wherein the adaptor is configured to rotate relative to the housing, wherein a low friction material is present at an interface between an exterior surface of adaptor and an interior surface of housing.

Embodiment 2: The bearing assembly according to embodiment 1, wherein the adaptor has an interior surface for engaging a rail, and the interior surface has a cross-sectional shape that is non-circular.

Embodiment 3: The bearing assembly according to embodiment 1, wherein the bearing assembly further comprises a rail, and wherein an exterior surface of the rail has a cross-sectional shape that is non-circular

Embodiment 4: The bearing assembly according to embodiment 3, wherein the non-circular cross section of the interior surface of the adaptor is complementary to the non-circular cross section of the exterior surface of the rail so as to fix the two components.

Embodiment 5: The bearing assembly according to any of the preceding embodiments, wherein the housing comprises a first piece and a second piece adapted to function as a clamp around the adaptor.

Embodiment 6: The bearing assembly according to any of the preceding embodiments, wherein the low friction material is fixed to an interior surface of the housing.

Embodiment 7: The bearing assembly according to embodiment 6, wherein the low friction material is adapted to function as a clamp.

Embodiment 8: The bearing assembly according to any of the preceding embodiments, wherein the low friction material is fixed to an exterior surface of the adapter.

Embodiment 9: The bearing assembly according to any of the preceding embodiments, wherein the low friction material is preformed according to the shape of the housing or the adapter.

Embodiment 10: The bearing assembly according to any of the preceding embodiments, wherein the low friction material comprises a thermoplastic polymer.

Embodiment 11: The bearing assembly according to any of the preceding embodiments, wherein an exterior surface of adapter comprises a rounded cross-section.

Embodiment 12: The bearing assembly according to embodiment 11, wherein an interior surface of the housing comprises a rounded shape complementary to the exterior surface of the adapter.

Embodiment 13: The bearing assembly according to embodiment 3, wherein the rail is adapted to rotatably support a photovoltaic panel.

Embodiment 14: The bearing assembly according to any of the preceding embodiments, wherein the low friction material comprises a material strip and wherein an exterior surface of the adapter comprises a groove adapted to accommodate the material strip.

Embodiment 15: An assembly for a tracker assembly of a power generation structure comprising: a rail adapted to rotate about a rotational axis; an adapter fixed to and rotatable with the rail; and a housing adapted to support the adapter and the rail; wherein the adapter and rail are adapted to rotate relative to the housing, and wherein a low friction material is present at the interface between an exterior surface of adapter and an interior surface of housing.

Note that not all of the features described above are required, that a region of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, however, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of assembly and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

1.-15. (canceled)

16. A bearing assembly for a tracker assembly of a power generation structure comprising:
an adaptor configured to be fixed to and rotatable with a rail; and
a housing adapted to support the adaptor, wherein the adaptor is configured to rotate relative to the housing, wherein a low friction material is present at an interface between an exterior surface of the adaptor and an interior surface of the housing.

17. The bearing assembly according to claim 1, wherein the adaptor has an interior surface for engaging a rail, and the interior surface has a cross-sectional shape that is non-circular.

18. The bearing assembly according to claim 1, wherein the bearing assembly further comprises a rail, and wherein an exterior surface of the rail has a cross-sectional shape that is non-circular.

19. The bearing assembly according to claim 3, wherein the non-circular cross-section of the interior surface of the adaptor is complementary to the non-circular cross-section of the exterior surface of the rail so as to fix the two components.

20. The bearing assembly according to claim 1, wherein the housing comprises a first piece and a second piece adapted to function as a clamp around the adaptor.

21. The bearing assembly according to claim 1, wherein the low friction material is fixed to an interior surface of the housing.

22. The bearing assembly according to claim 6, wherein the low friction material is adapted to function as a clamp.

23. The bearing assembly according to claim 1, wherein the low friction material is fixed to an exterior surface of the adaptor.

24. The bearing assembly according to claim 1, wherein the low friction material is preformed according to the shape of the housing or the adaptor.

25. The bearing assembly according to claim 1, wherein the low friction material comprises a thermoplastic polymer.

26. The bearing assembly according to claim 1, wherein an exterior surface of the adaptor comprises a rounded cross-section.

27. The bearing assembly according to claim 11, wherein an interior surface of the housing comprises a rounded shape complementary to the exterior surface of the adaptor.

28. The bearing assembly according to claim 3, wherein the rail is adapted to rotatably support a photovoltaic panel.

29. The bearing assembly according to claim 1, wherein the low friction material comprises a material strip and wherein an exterior surface of the adaptor comprises a groove adapted to accommodate the material strip.

30. An assembly for a tracker assembly of a power generation structure comprising:
a rail adapted to rotate about a rotational axis;
an adaptor fixed to and rotatable with the rail; and
a housing adapted to support the adaptor and the rail; wherein the adaptor and rail are adapted to rotate relative to the housing, and wherein a low friction material is present at the interface between an exterior surface of the adaptor and an interior surface of the housing.

31. The assembly according to claim 15, wherein the housing comprises a first piece and a second piece adapted to function as a clamp around the adaptor.

32. The assembly according to claim 15, wherein the low friction material is fixed to an interior surface of the housing.

33. The assembly according to claim 15, wherein the low friction material is fixed to an exterior surface of the adaptor.

34. The assembly according to claim 15, wherein the low friction material comprises a thermoplastic polymer.

35. The assembly according to claim 15, wherein the low friction material comprises a material strip and wherein an exterior surface of the adaptor comprises a groove adapted to accommodate the material strip.
